(19) United States
(12) Patent Application Publication
(10) Pub. No.: US 2024/0283791 A1
(43) Pub. Date: Aug. 22, 2024

(54) Authorization of a User Equipment to Access a Resource

(71) Applicant: Telefonaktiebolaget LM Ericsson (publ), Stockholm (SE)

(72) Inventors: Patrik Salmela, Espoo (FI); Mohit Sethi, Helsinki (FI)

(21) Appl. No.: 18/568,900

(22) PCT Filed: Jul. 5, 2021
(86) PCT No.: PCT/EP2021/068427

§ 371 Date: Dec. 11, 2023

(51) Int. Cl. H04L 9/40; H04L 61/503

(52) U.S. Cl. CPC H04L 63/0892; H04L 61/503

(57) ABSTRACT

Methods and apparatus are provided. In an example aspect, a method of authorization in a network node is provided. The method comprises receiving, from an authorization node, an indication that a User Equipment, UE, is authorized to access a resource, and receiving, from the authorization node, an indication of network access parameters for the UE for accessing the resource.

### TECHNICAL FIELD

Examples of the present disclosure relate to authorization of a User Equipment (UE) to access a resource, for example in a network node or authorization node in a network.

### BACKGROUND

A User Equipment (UE) may wish to connect to a wireless communication network, such as for example a 4G or 5G cellular network, and access a resource such as the internet or an external network such as a private or enterprise network via a core network of the wireless network (e.g. a 5G core network, 5GC). The UE first connects to the wireless network following primary authentication between the UE and the network. For private and enterprise networks, where there is a restriction as to the users or UEs that are allowed to access the network, there is typically an IPsec or other secure tunnel between the core network and the external network. This makes it possible for both endpoints to trust each other, based on the negotiated and trusted mutually authenticated tunnel. For example, a private network may trust traffic coming from an IPsec tunnel established with the trusted core network.

To limit which User Equipments (UEs) are allowed to send data through the secure tunnel, the core network can assign the external network a Data Network Name (DNN), which can be private. Public DNNs are also used, e.g. for internet access the DNN is typically “internet”. DNN can be seen as an identifier of the network the external facing interface of the User Plane Function (UPF) connects to for the specific Packet Data Units (PDU) session. A UPF can serve multiple DNNs. The DNN is bound to the PDU session established for the UE or subscription. A UE or subscription can establish a PDU session only to those DNNs that are configured for the subscription, i.e. the core network performs access control based on the subscription information and only allows subscriptions configured with a specific DNN to create a PDU session for the DNN.

To tighten the access control for the DNN, the external network can also be involved through Secondary Authentication (SA). When enabled for a DNN, the core network may not allow a UE to establish a PDU session with the specific DNN unless also SA has been successfully performed. SA may involve for example an Extensible Authentication Protocol (EAP) method exchange between the UE and an Authentication, Authorization and Accounting (AAA) server, typically located in the external network, using external network credentials of the UE. Thus, only UEs that also possess valid credentials for the external network can establish a PDU session with the DNN. The EAP exchange is run with a Session Management Function (SMF) in the core network (e.g. 5GC) acting as EAP authenticator and, typically, the AAA server in the external network acting as EAP server. The EAP exchange between the EAP authenticator and EAP server can be carried out using Remote Authentication Dial-In User Service (RADIUS) or Diameter protocol and messages.

The Extensible Authentication Protocol (EAP) is a framework with support for multiple authentication methods and can run directly over the link layer without IP connectivity. In EAP, the entity requiring authentication is termed as the EAP authenticator while the other end point is referred to as the EAP peer. EAP allows the use of a backend authentication server with the authenticator simply behaving as a pass-through. The entity in which EAP authentication terminates is referred to as the EAP server. Thus, the EAP server can be part of the authenticator or the backend server.

EAP is often deployed together with a protocol for authentication, authorization, and accounting (AAA) such as RADIUS and Diameter. When EAP is used with AAA protocols, the authenticator always acts as a pass-through. In such deployments, the AAA server, EAP server, and backend authentication server can refer to the same entity.

RADIUS and Diameter protocols have many attribute value pairs (AVPs) that can be used for sending information from the authenticator to the AAA server. This can include information such as the MAC address of the EAP peer, etc. RADIUS and Diameter can also be used to send AVPs from the AAA server to the authenticator. This can for example include policy and authorization information in the form of access control lists etc.

In the 5G context, when secondary authentication is used, the SMF acts as the authenticator and uses RADIUS or Diameter to transport EAP messages to the AAA server (which may be located in the external network).

With 5G cellular networks, the concept of private 5G networks has been introduced. These non-public networks (NPN) can be deployed in different ways. A standalone NPN (SNPN) is basically a standalone 5G network, not relying on network functions provided by a Public Land Mobile Network (PLMN), but possibly utilizing a Radio Access Network (RAN) of a PLMN. The entity operating the SNPN could be for example an enterprise. Alternatively, the NPN can be deployed by at least partly utilizing the infrastructure of a PLMN, which is called public network integrated NPN (PNI-NPN). In this case, the subscription credentials are managed by the PLMN. PNI-NPN can be deployed as a network slice in the PLMN network or as an external data network in which some of the network functions (NFs) of the NPN can be run. In the case of PNI-NPN with NPN deployed as an external data network, in addition to primary registration/authentication, SA may be used to authenticate and authorize the UE to access the NPN network via the PLMN network

5G Local Area Network (LAN)-type services can provide a LAN with 5G capabilities (e.g., performance, long-distance access, mobility, security) to allow a restricted set of UEs to communicate amongst each other. To provide a 5G LAN service, the 5G system supports optimized routing by enabling support for local switching at the UPF without having to traverse the data network for UE—UE communication when the same UPF serves the two UEs. However, a 5G LAN may have a DNN associated with a 5G LAN, i.e. SA may be performed to authenticate and authorize the UE accessing such a DNN as no 5G LAN-specific authentication or authorization has been defined, for example in 3GPP TS 23.501 V17.0.0 and 33.501 V17.1.0, which are incorporated herein by reference.

Thus, SA can be used for authentication/authorization to external data networks, PNI-NPN, as well as 5G LAN (to name a few).

5G slicing can be used for providing multiple instances, or slices, of NFs or network features, or to provide PNI-NPN as discussed above. A slice can encompass one or multiple NFs. NFs can either be slice specific, i.e. dedicated to a specific slice, or shared between multiple slices. The 5G network controls which subscriptions use which slices, thereby isolating the traffic of one slice from the traffic of the other slices.

The Network Slice Specific Authentication and Authorization Function (NSSAAF), as the name suggests, can assist with network slice authentication and authorization with an AAA Server (AAA-S), which could be operated by the operator or a third party. Slice authentication is similar to SA in that there is an EAP exchange to gain further access after a successful primary authentication. The Access and Mobility Management Function (AMF) takes on the role of EAP authenticator.

The Manufacturer Usage Description (MUD) Specification, specified in RFC 8520, which is incorporated herein by reference, specifies a MUD file that describes various aspects of a device. The MUD file is typically created by the device manufacturer and includes information related to the communication patterns and policies of the device, i.e. what services the device is expected to and/or allowed to connect to, etc. MUD is designed for (but not technically limited to) IoT devices with clear and simple communication patterns that can easily be described in a MUD file. A personal computer would typically have a very complex communication pattern that is unpredictable and that would be difficult to describe. The MUD file is intended for use by the access network provider to limit the communication of the MUD device, or “thing” in MUD terminology, to pre-defined communication patterns and thereby improve security of the device. The MUD file could also be used for configuring the access network to fit the requirements of the connected device, e.g. related to reachability through Network Address Translation (NAT), etc.

The MUD architecture, in addition to the thing itself, includes the MUD manager in the access network and the MUD server, e.g. hosted by the manufacturer. When the thing connects to the access network, it will communicate the URL pointing to the MUD file of the device. The access network intercepts this MUD URL and forwards it to the MUD manager in the access network. The MUD manager uses the URL to connect to the MUD server (to which the URL points) and download the MUD file pointed to by the URL. The MUD manager then interprets the MUD file and applies network access policies based on the content of the MUD file for the attached thing.

The MUD URL could be communicated by the thing to the MUD manager or access network in multiple ways, e.g. in a DHCP request or in an EAP message used for access authentication. RFC 8520 defines a MUD URL X.509 extension for client certificates. The client certificate can then be exchanged via EAP-TLS/EAP-TEAP, etc., the certificate carrying the MUD URL.

### SUMMARY

Network operators, such as for example an enterprise or operator of a private network, may wish to be able to apply policies for the traffic of its subscribers. While this may be done in the private or enterprise network controlled by the operator, applying some policies earlier, such as for example. in the access network connecting the client or UE to the private or enterprise network, may be desirable and may give better control for the operator, especially if the clients/UEs can also connect to networks other than the private or enterprise network.

One aspect of the present disclosure provides a method of authorization in a network node. The method comprises receiving, from an authorization node, an indication that a User Equipment, UE, is authorized to access a resource, and receiving, from the authorization node, an indication of network access parameters for the UE for accessing the resource.

Another aspect of the present disclosure provides a method of authorization in an authorization node. The method comprises receiving an authorization request for a User Equipment, UE, to access a resource, sending, to a network node, an indication that the UE is authorized to access the resource, and sending, to the network node, an indication of network access parameters for the UE for accessing the resource.

A further aspect of the present disclosure provides apparatus for authorization in a network node. The apparatus comprises a processor and a memory. The memory contains instructions executable by the processor such that the apparatus is operable to receive, from an authorization node, an indication that a User Equipment, UE, is authorized to access a resource, and receive, from the authorization node, an indication of network access parameters for the UE for accessing the resource.

A still further aspect of the present disclosure provides apparatus for authorization in an authorization node. The apparatus comprises a processor and a memory. The memory contains instructions executable by the processor such that the apparatus is operable to receive an authorization request for a User Equipment, UE, to access a resource, send, to a network node, an indication that the UE is authorized to access the resource, and send, to the network node, an indication of network access parameters for the UE for accessing the resource.

An additional aspect of the present disclosure provides apparatus for authorization in a network node. The apparatus is configured to receive, from an authorization node, an indication that a User Equipment, UE, is authorized to access a resource, and receive, from the authorization node, an indication of network access parameters for the UE for accessing the resource.

Another aspect of the present disclosure provides apparatus for authorization in an authorization node. The apparatus is configured to receive an authorization request for a User Equipment, UE, to access a resource, send, to a network node, an indication that the UE is authorized to access the resource, and send, to the network node, an indication of network access parameters for the UE for accessing the resource.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method 200 of authorization in an authorization node;

FIG. 2 is a flow chart of an example of a method 200 of authorization in an network node;

FIG. 3 shows an example of a procedure of secondary authentication in a communication system according to examples of this disclosure;

FIG. 4 shows an example of a procedure of slice authentication in a communication system according to examples of this disclosure;

FIG. 5 is a schematic of an example of an apparatus for authorization in a network node;

FIG. 6 is a schematic of an example of an apparatus for authorization in an authorization node; and

FIG. 7 is a block diagram illustrating a virtualization environment QQ500 in which functions implemented by some embodiments may be virtualized.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Manufacturer Usage Description (MUD) provides tools for providing the access network with policies and other relevant information that can be used for managing the connectivity and traffic of individual clients or UEs. There may also be other ways of distributing policies, etc. For example, for 3GPP there may be policies configured for the subscription, e.g. in the core network, but external entities have limited ability to affect these. With the introduction of private networks there are use cases where the private network operator, e.g. an enterprise, may wish to be able to apply policies for the traffic of its subscribers. While this may be done in the private or enterprise network controlled by the enterprise, applying some policies earlier, e.g. in the access network connecting the client or UE to the private or enterprise network may be desirable and may give better control for the enterprise, especially if the clients/UEs can also connect to networks other than the private network. Also, large numbers of devices managed by an enterprise may benefit from the possibility to apply policies for their traffic at the network (e.g. RAN) access level. This may also apply to access to a resource, such as an external network e.g. an enterprise or private network, as well as any other resource in the network such as a network slice, network function, the internet, etc.

In some examples of this disclosure, authorization for a UE to access a resource, such as for example secondary authentication or slice authentication, may be performed e.g. using the EAP framework, and can be done e.g. using credentials and an AAA server of an external party. The external party may for example be an enterprise whose devices are performing the secondary or slice authentication. Proposed herein are methods and apparatus in which a network node such as an AAA server can communicate information to the access network (e.g. 5GC) identifying policies or other network access parameters that should be applied for the authenticated device. This could be done using MUD, such as a MUD file or link or pointer to a MUD file, or any other suitable solution and format for providing or indicating network access parameters.

Examples of this disclosure may also apply to primary authentication (PA). For example, primary authentication may use an authorization or authentication node external to a network, such as for example an external AAA server. This may be external to a network (e.g. a cellular or core network) that includes a network node through which primary authentication takes place. Conventionally, primary authentication is by default carried out with a Home Public Land Mobile Network (HPLMN), and can be done using EAP. In some examples of this disclosure, primary authentication may be done towards the home operator network (HPLMN), but the home network may use an external authorization node such as an AAA server, e.g. one deployed by a private network or an enterprise.

Examples of this disclosure may have one or more of the following advantages. For example, network access parameters (e.g. policies) may be issued for devices performing for example SA or slice authentication using an external AAA server (e.g. in a network external to a core network). This and other examples may not need modification to currently used protocols and (external) interfaces, except in certain examples, such as for example piggybacking data or indications in certain messages such as EAP SUCCESS messages, or adding the information as an attribute-value pair (AVP) to a RADIUS/DIAMETER message carrying the EAP SUCCESS message.

Certain examples make it possible to use network access parameters (Manufacturer Usage Description, MUD, is referred to here as an example) in 3GPP networks without modification to devices or used protocols. Traditional MUD would have the UE provide a URL to the MUD file and that would have to be integrated somehow into existing signaling between UE and network, i.e. changes to UE and protocols. Example approaches presented herein has data or indications included in one or more existing messages, and/or furthermore may obtain network access parameters (or pointers thereto) from sources other than the UE itself.

In cases where a device such as a UE specifies its own MUD file, the device could itself decide whether to apply MUD selectively and decide not to do so in some cases. Likewise, a MUD device could send the MUD file of some other device to get more favorable MUD file and thus policies applied for it. In a particular use case, an enterprise may not want certain subscriptions to simultaneously access an enterprise private slice and the public Internet. If the device is in control of providing MUD URL resulting in such policies, the device owner can potentially select to not send the MUD URL. Examples of this disclosure may move control of network access parameters such as a MUD file to the network, and devices such as MUD devices will always have the correct MUD applied, in accordance with network policy.

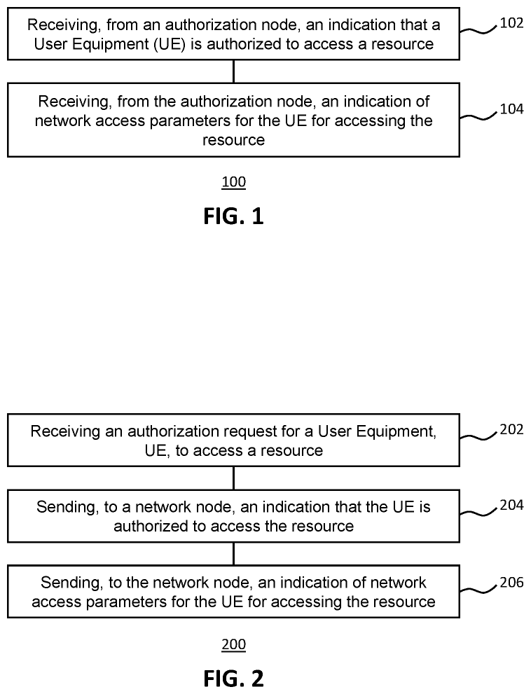

FIG. 1 is a flow chart of an example of a method 100 of authorization in a network node. The network node may be for example a node in a core network, e.g. a cellular core network or 5G core network (5GC). In some examples, the network node may be a Session Management Function (SMF), Access and Mobility Management Function (AMF), User Plane Function (UPF), Authentication Server Function (AUSF) or AUSF-proxy. The method 100 comprises, in step 102, receiving, from an authorization node, an indication that a User Equipment, UE, is authorized to access a resource. The authorization node may be for example a node in a network containing the network node. That is, for example, the network node and the authorization node may be in the same core network or 5GC. Alternatively, for example, the authorization node is in a network external to the network containing the network node. For example, the authorization node may be in an external network such as a private or enterprise network. The authorization may in some examples be an Authentication, Authorization and Accounting (AAA) node.

The resource may comprise for example any resource in the network (or another network) that the UE is trying to access. Examples of a resource include one or more of the following: a network slice, a network function, a network containing the network node, a network external to a network containing the network node, a public network integrated non-public network, PNI-NPN, a standalone non-public network, SNPN, a private network, an enterprise network, and a network having an indicated Data Network Name, DNN. However, this list is not exhaustive and the UE may wish to access one or more other types of resource.

The method 104 then comprises, in step 104, receiving, from the authorization node, an indication of network access parameters for the UE for accessing the resource. The indication of network access parameters may in some examples indicate to the network (e.g. the core network or 5GC) how access to the resource or to the network by the UE should be managed. In some examples, the network access parameters may comprise a policy for access to the network or resource by the UE. In some examples, therefore, the method 100 may comprise applying the policy, though in other examples the policy may be applied or implemented by some other node in the network such as a Session Management Function (SMF). In some examples, the network access parameters may include one or more of: one or more networks, network slices, services and/or resources that the UE is authorized to access; one or more networks, network slices and/or resources that the UE is not authorized to access; a Quality of Service, QoS, for the UE for accessing the resource; one or more times when the UE is permitted to access the resource; and expected traffic patterns of the UE. Thus, for example, application of the network access parameters by the access network may implement these policies at the network access level and may not need implementation by the resource or the operator of the resource, such as an enterprise or private network or operator.

The indication of network access parameters of the UE for accessing the resource may be for example the parameters themselves, or alternatively the indication may be a pointer to the parameters such as a Universal Resource Locator (URL). In some examples, the parameters comprise a Manufacturer Usage Description (MUD) file. Therefore, the indication of network access parameters of the UE for accessing the resource may be the MUD file itself or may alternatively be a pointer, location or URL from where the MUD file can be downloaded.

In some examples, the indication that the UE is authorized to access the resource and the indication of network access parameters for the UE for accessing the resource are received in a single message from the authorization node. This may be for example an Extensible Authentication Protocol, EAP, message such as an EAP SUCCESS message. Alternatively, for example, this message may be a Diameter Protocol message or a Remote Authentication Dial-In User Service, RADIUS, Protocol message, or may be an EAP SUCCESS message contained within a RADIUS or Diameter protocol message. Where the indications are received in separate messages, either message may be one of an EAP SUCCESS message or a RADIUS or Diameter protocol message (or an EAP message such as SUCCESS within a RADIUS or DIAMETER protocol message).

In some examples, the method 100 may comprise forwarding an indication of network access parameters for the UE for accessing the resource to a further network node. This may be the same as the indication that is received from the authorization node in some examples. In other examples, however, the forwarded indication may be different. For example, the received indication may be a pointer (e.g. a URL) to the parameters, and the forwarded indication may be the parameters themselves, in which case the network node may retrieve the parameters using the pointer. Alternatively, for example, the forwarded parameters may comprise a subset of the received parameters (or those pointed to by a pointer). The further network node to which the indication is forwarded may comprise for example a Session Management Function (SMF), Access and Mobility Management Function (AMF), Policy Control Function (PCF) or User Plane Function (UPF).

The indication that the UE is authorized to access a resource and the indication of network access parameters for the UE for accessing the resource may in some examples be received in response to an authorization request for the UE (which may be received from the UE itself) to access the resource. This request may be to the authorization node or another node, such as the network node for example. The authorization request may in some examples be an EAP authorization/authentication request. The method 100 may thus in some examples, comprise forwarding the authorization request from the UE to the authorization node. This may be done by encapsulating the authorization request in another message such as a RADIUS or Diameter protocol message. For example, an EAP authorization request may be encapsulated in a RADIUS or Diameter protocol message and sent to the authorization node. The authorization request may comprise for example a primary authentication request, a secondary authentication request or a slice authentication request.

FIG. 2 is a flow chart of an example of a method 200 of authorization in an authorization node, such as for example an Authentication, Authorization and Accounting (AAA) node or server. The method 200 comprises, in step 202, receiving an authorization request for a User Equipment, UE, to access a resource. The resource may be for example any one or more of the resource types identified above. The authorization request may be received from the UE (e.g. via a network node) or from a network node, where the network node may be in a core network (e.g. 5GC) or access network. The authorization request may in some examples be a primary authentication request, a secondary authentication request or a slice authentication request.

The method 200 also comprises, in step 204, sending, to a network node (which may be the network node from which the request is received), an indication that the UE is authorized to access the resource. The authorization node may be, for example, in a network containing the network node or in a network external to the network containing the network node. Thus for example the authorization node may be in an external, private or enterprise network from the point of view of the network containing the network node. The network node may be for example a SMF, UPF, AMF, AUSF or AUSF-proxy.

Step 206 of the method 200 comprises sending, to the network node, an indication of network access parameters for the UE for accessing the resource. The indication of network access parameters may be for example the parameters themselves or a pointer to the parameters as suggested above. The parameters may be a policy, MUD file or any other type of parameters as suggested above. In some examples, the network access parameters (or an indication thereof) may be retrieved from another node, such as a policy server.

The indication that the UE is authorized to access the resource in some examples comprises or is comprised in an EAP SUCCESS message, a Diameter Protocol message or a RADIUS Protocol message. For example, the indication may be included in an EAP SUCCESS message encapsulated in a RADIUS or Diameter protocol message. Additionally or alternately, for example, the authorization request may be an Extensible Authentication Protocol, EAP, authorization request and/or may be received from the network node in a Diameter Protocol message or a Remote Authentication Dial-In User Service, RADIUS, Protocol message.

A specific example will now be described. While examples of this disclosure can be applied in various scenarios, such as for example when EAP is run using an AAA/EAP server hosted by the operator of the core network, the following specific example relates to where the AAA/EAP server is hosted by an external entity, such as an enterprise buying services from the core network operator. However, the following examples, and also other examples of this disclosure, may also be applied to various other scenarios.

In some examples, methods disclosed herein may be used for primary authentication (PA). For example, a network node such as an AUSF or an AUSF-proxy (e.g. AUSF forwards to AUSF/AAA proxy, which forwards to external AAA) forwards primary authentication messages to an authorization node, such as an AAA server, in an external network. In some examples, primary authentication may be performed in accordance with the current standard, except the network node (e.g. AUSF or AUSF-proxy), which typically is the authentication end-point, forwards to the external authorization node and receives the network access parameters (e.g. in or with an EAP SUCCESS message) from the authorization node.

In certain scenarios while the UE/subscription has already registered and authenticated with the core network, such as for example with the 5GC, accessing some resources and networks might require a secondary authentication to be run towards an external AAA server, for example. This could be secondary authentication to gain access to a specific DNN/external network, for slice authentication to get access to a specific slice, or some other additional authentication to get access to some other access-controlled resource(s).

A network function (NF) in the operator/core network may take on the role of EAP authenticator when running the EAP protocol between the UE and external AAA/EAP server. Potential NFs to take on this role include the SMF for secondary authentication and AMF for slice authentication, or AUSF or AUSF-proxy (e.g. in the case of primary authentication). The selected EAP method is run up until the final EAP SUCCESS message being transmitted from EAP server towards EAP authenticator. At this point, the EAP server includes network access parameters (such as policy information for example), or a pointer to such, either as piggybacked data in the EAP SUCCESS message or as an attribute-value pair (AVP) in the RADIUS/Diameter message carrying the EAP SUCCESS message. These are however illustrative examples, and any other suitable way for the external server to provide this information on the network access parameters to the core network function may be used, including other messages and message types. The EAP SUCCESS message reaches the EAP authenticator, which in addition to typical handling of the EAP SUCCESS message also extracts this additional information from the EAP or RADIUS/Diameter message. The EAP authenticator then proceeds to finalize the EAP exchange by transmitting the EAP SUCCESS message (e.g. without the additional information) to the UE.

The policy related information or network access parameters should be communicated by the EAP authenticator to the Policy Control Function (PCF), or other policy handling NF, where the PCF (or other NF) can incorporate the external policies with already existing local policies related to the subscription and/or session for the UE. If the received information is a pointer to the policy information, e.g. a MUD URL, the EAP authenticator can either itself fetch the policy information and pass that along to the PCF, or pass the pointer to the PCF, which can in turn fetch the policy information.

The PCF may have pre-existing, internal policy information or network access parameters for the subscription or the session and should then merge this with the received external policy information or network access parameters. The resulting policies or parameters should then be distributed by the PCF to those NFs that need them. Typically, this may include at least the SMF. The policies are then applied for the traffic of the session, or even subscription wide, without the UE having knowledge of these policies being fetched and applied. This for example makes it possible for the external network to control how the UE is allowed to connect and behave.

The content of the policy information or parameters, which may be a MUD file or otherwise, can take on many forms. Some examples are given above, but other examples include one or more of limiting the UE or device from using public Internet during certain times of day, limiting which hosts it is allowed to connect to or be connected from, how often or how much data it is allowed to transmit, what PDU sessions/DNNS are allowed to be active simultaneously, and/or other possible restrictions, policies or parameters. Additionally or alternatively, the network access parameters may include information regarding the expected behavior (e.g. sleep patterns) of the UE. This information could be used for example to configure a Radio Access Network (RAN) to optimize network performance based on the expected behavior.

For example, a UE connecting to a private 5G network (PNI-NPN) or a network slice could have policies, defined by the enterprise being served by the NPN/slice, to limit access to the NPN or slice during certain hours (e.g. only during business hours for operational personnel, or only outside operational hours for maintenance personnel). While this could be enforced in an external network the NPN/slice connects to, not all scenarios have such an external network nor policy enforcement functionality, and the core/access network operator would not have access to such external policies by default.

A further example is that there could be limits regarding what other networks the UE or subscription is allowed to access while having an active context with an NPN or slice. If a subscription has an active context to the NPN/slice and at the same time another active context to the Internet, the UE could be a gateway between the Internet and the NPN/slice. This is a scenario that could be prevented by external policies defined by the relevant stakeholder, e.g. the enterprise being served by NPN or slice. In this case the policy could state for example that if there is an active context to a specific slice or NPN, then other active contexts are not allowed, or certain other active contexts are allowed or disallowed.

In some examples, secondary authentication (SA) is run for example between the UE and AAA server (in many cases an external AAA server, though examples of this disclosure may also be applied for a server in the core network such as 5GC). The SMF may act as EAP authenticator. The SMF (among other entities) interacts with the PCF to retrieve the session management policy information corresponding to the PDU session of the UE/subscription. It also acts as a consumer of the PCF-provided session management policy service. In some examples, as SA is being completed and the AAA server is about to send the EAP SUCCESS message to the SMF, it includes policy information relating to the device being authenticated in the EAP SUCCESS message as piggybacked data or in AVP in the RADIUS/ Diameter message carrying the EAP SUCCESS message. This information could be policy information in any format. One option is to utilize a MUD file by either having the AAA server include the MUD file URL associated with the specific device, or even including the MUD file of the device. MUD files are typically defined for a specific device type, i.e. all devices of a specific type have the same MUD file. However, in some scenarios there may be per-device MUD files. For example, an enterprise having its own AAA server for SA could also generate per-device MUD files and distribute them to the core network in this way, either by directly providing the MUD files in EAP SUCCESS messages or by having a MUD server with the files and providing a pointer such as a MUD URL to point to the corresponding MUD file.

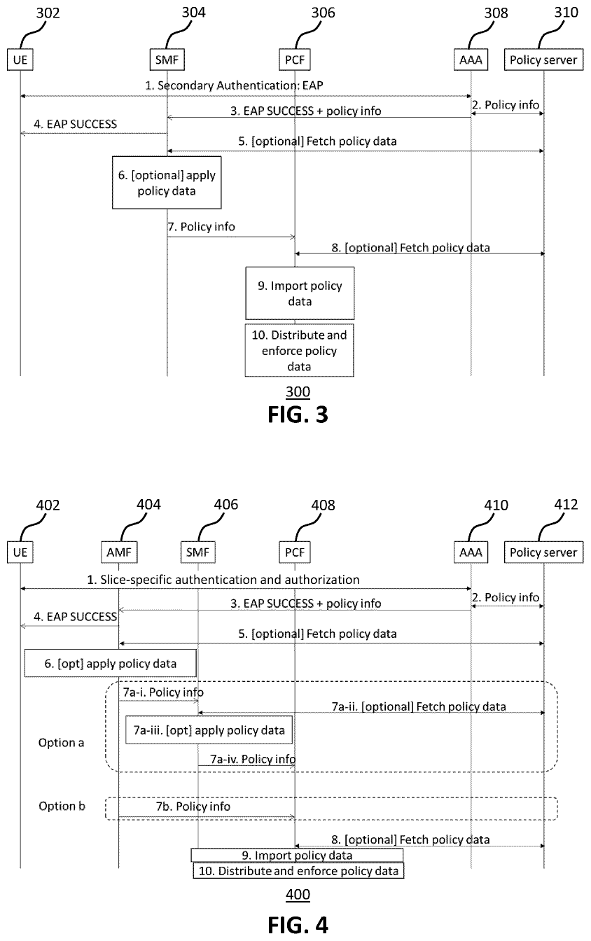

The SMF would thus in some examples receive the policy information with the EAP SUCCESS message, either directly by including the policy information in the message or a pointer to where it can be fetched from, e.g. via a MUD URL. Since it is already part of the policy handling of subscriptions via its interaction with PCF, the SMF would be a logical entry point for externally provided policy information. The SMF could therefore optionally enforce the received policy information and provide it to PCF for checking, verification, inclusion, and decision of how to apply the received policies. The PCF could then based on local policies and received external policies provide relevant policy information to various network functions, including the SMF. The flow is shown in FIG. 3, which shows an example of a procedure 300 of secondary authentication in a communication system according to examples of this disclosure. The communication system includes UE 302, SMF 304, PCF 306, AAA server 308 and policy server 310. The example procedure 300 includes the following steps illustrated in FIG. 3:
1. UE 302 runs secondary authentication using EAP with the AAA/EAP server 308, with SMF 304 acting as EAP authenticator
2. AAA server 308 obtains policy information (i.e. network access parameters) for the UE, possibly from a policy server 310 or from local database or similar
   a. Policy information could be the policy data itself or a pointer to a file containing the policy data, such as a MUD file.
3. Once EAP has run successfully, AAA server 308 includes policy info in the EAP SUCCESS message
4. SMF 304, acting as EAP authenticator, extracts policy info and then forwards the remaining EAP SUCCESS message to the UE 302
   a. This step could occur in parallel with any one or more of steps 5-10
5. If received policy info is a pointer to the policy data, the SMF 304 might optionally fetch the policy data from policy server 310 based on the received pointer.
6. The SMF 304 might optionally apply the policy data for the current session
7. The SMF 306 communicates the policy info to the PCF 306
8. If the policy info received from SMF 304 is a pointer, the PCF 306 fetches the policy data from policy server 310
9. The PCF 306 imports the received policy data
   a. This includes evaluating the policy data, verifying it is acceptable, and merging it with existing local policy data
10. The PCF 306 distributes and enforces the new set of policies as necessary.
   a. This could include terminating some current session of the subscriber if new session forbids other sessions to be active simultaneously, or rejecting a session currently being set up, etc.

In some examples, slice authentication using an external AAA/EAP server is may be similar to secondary authentication examples illustrated above. In a specific example, one difference is that instead of the SMF taking on the role of EAP authenticator in slice authentication, it is the AMF taking on that role. In this example, the AMF collaborates with the SMF when setting up sessions or PDU contexts, and also interacts with the PCF, so having the AMF receive the network access parameters (or MUD file or pointer to MUD file) piggybacked in the EAP SUCCESS message, or as an attribute-value pair in the RADIUS/Diameter message carrying the EAP message, is a useful arrangement.

FIG. 4 shows an example of a procedure 400 of slice authentication in a communication system according to examples of this disclosure. The communication system includes UE 402, AMF 404, SMF 406, PCF 408, AAA server 410 and policy server 412. The example procedure 400 includes the following steps illustrated in FIG. 4:
1. Slice authentication is run between UE 402 and AAA server 410 which is located in an external network
2. AAA server 410 obtains policy information (network access parameters) for the UE, e.g. from policy server 412.
3. AAA server 410 includes policy information (parameters) or a pointer to them in an EAP SUCCESS message to AMF 404.
4. EAP authenticator (AMF 404) extracts policy info/parameters and forwards rest of EAP SUCCESS message to UE 402.
   a. This step could occur in parallel with any one or more of steps 5-10
5. If received policy info is a pointer to the policy data, the AMF 404 might optionally fetch the policy data from the policy server 412 based on the received pointer.
6. The AMF 404 might optionally apply the policy data for the current session
7. There are two options for what happens next:
   a. In option a, AMF 404 interacts with SMF 406
      i. AMF 404 sends policy info to SMF 406
      ii. If received policy info is a pointer to the policy data, the SMF 406 might optionally fetch the policy data from the policy server 412 based on the received pointer.
      iii. The SMF 406 might optionally apply the policy data for the current session
      iv. SMF 406 communicates policy info to PCF 408
   b. In option b, AMF404 interacts with PCF 408; AMF communicates policy info to PCF 408
8. If the policy info received from AMF 404 SMF 406 is a pointer, the PCF 408 fetches the policy data from policy server 412
9. The PCF 408 imports the received policy data
   a. This includes evaluating the policy data, verifying it is acceptable, and merging it with existing local policy data
10. PCF 408 distributes and enforces the new set of policies as necessary.
   a. This could include terminating some current session of the subscriber if new session forbids other session to be active simultaneously, or rejecting session currently being set up, etc.

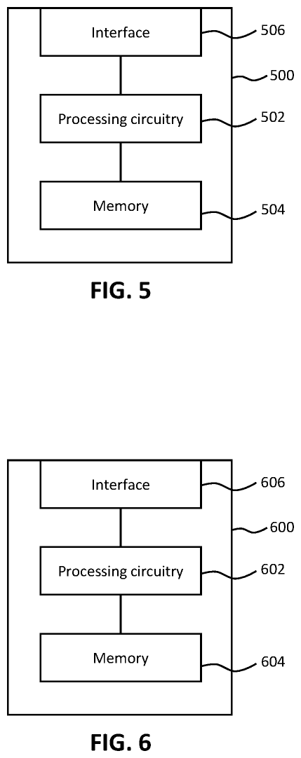

FIG. 5 is a schematic of an example of an apparatus 500 for authorization in a network node. The apparatus 500 comprises processing circuitry 502 (e.g. one or more processors) and a memory 504 in communication with the processing circuitry 502. The memory 504 contains instructions executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable to receive, from an authorization node, an indication that a User Equipment, UE, is authorized to access a resource, and receive, from the authorization node, an indication of network access parameters for the UE for accessing the resource. In some examples, the apparatus 500 is operable to carry out the method 100 described above with reference to FIG. 1.

FIG. 6 is a schematic of an example of an apparatus 600 for authorization in an authorization node. The apparatus 600 comprises processing circuitry 602 (e.g. one or more processors) and a memory 604 in communication with the processing circuitry 602. The memory 604 contains instructions executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

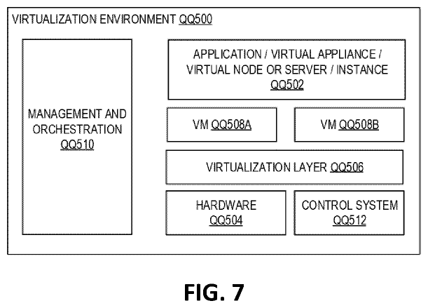

FIG. 7 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

In one embodiment, the memory 604 contains instructions executable by the processing circuitry 602 such that the apparatus 600 is operable to receive an authorization request for a User Equipment, UE, to access a resource, send, to a network node, an indication that the UE is authorized to access the resource, and send, to the network node, an indication of network access parameters for the UE for accessing the resource. In some examples, the apparatus 600 is operable to carry out the method 200 described above with reference to FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-43. (canceled)

44. A method of authorization in a network node, the method comprising:
receiving, from an authorization node, an authorization indication indicating that a User Equipment (UE) is authorized to access a resource; and
receiving, from the authorization node, an access indication indicating network access parameters for the UE to access the resource.

45. The method of claim 44, wherein the authorization indication and the access indication are received in a message from the authorization node.

46. The method of claim 44, further comprising sending a further access indication indicating the network access parameters to a further network node.

47. The method of claim 46, wherein:
the further access indication forwarded to the further network node is the same as the access indication received from the authorization node; and/or
the further access indication of network access parameters comprises the network access parameters or a pointer to the network access parameters.

48. The method of claim 46, wherein the further network node comprises a Session Management Function (SMF), Access and Mobility Management Function (AMF), Policy Control Function (PCF), or User Plane Function (UPF).

49. The method of claim 44, wherein the network access parameters comprise a Manufacturer Usage Description (MUD) file or a pointer to the MUD file.

50. The method of claim 44, wherein the network access parameters comprise a policy for access to the resource by the UE.

51. The method of claim 50, further comprising applying the policy for access to the resource by the UE.

52. The method of claim 44, wherein the authorization indication and the access indication are received in response to an authorization request from the UE to the authorization node to access the resource.

53. The method of claim 52, further comprising forwarding the authorization request from the UE to the authorization node.

54. The method of claim 52, wherein:
the authorization request is an Extensible Authentication Protocol (EAP) authorization request; and
the method further comprises sending the authorization request to the authorization node in a Diameter Protocol message or a Remote Authentication Dial-In User Service (RADIUS) Protocol message.

55. A method of authorization in an authorization node, the method comprising:
receiving an authorization request for a User Equipment (UE) to access a resource;
sending, to a network node, an authorization indication indicating that the UE is authorized to access the resource; and
sending, to the network node, an access indication indicating network access parameters for the UE to access the resource.

56. The method of claim 55, wherein the authorization indication and the access indication are sent in a message to the network node.

57. The method of claim 55, wherein the network access parameters comprise a policy for access to the resource by the UE.

58. An apparatus for authorization in a network node, the apparatus comprising:
a processor and a memory, the memory containing instructions executable by the processor such that the apparatus is configured to:
receive, from an authorization node, an authorization indication indicating that a User Equipment (UE) is authorized to access a resource; and
receive, from the authorization node, an access indication indicating network access parameters for the UE to access the resource.

59. The apparatus of claim 58, wherein the authorization indication and the access indication are received in a message from the authorization node.

60. The apparatus of claim 58, further comprising forwarding the access indication to a further network node.

61. An apparatus for authorization in an authorization node, the apparatus comprising:
a processor and a memory, the memory containing instructions executable by the processor such that the apparatus is operable to:
receive an authorization request for a User Equipment (UE) to access a resource;
send, to a network node, an authorization indication indicating that the UE is authorized to access the resource; and
send, to the network node, an access indication indicating network access parameters for the UE to access the resource.

62. The apparatus of claim 61, wherein the authorization indication and the access indication are sent in a message to the network node.

63. The apparatus of claim 61, wherein the network access parameters for the UE to access the resource comprise a policy for access to the resource by the UE.
